(19) United States
(12) Patent Application Publication
(10) Pub. No.: US 2012/0003326 A1
(43) Pub. Date: Jan. 5, 2012

(54) DETERGENT, CLEANING AGENT, AFTERTREATMENT AGENT, OR WASHING AID CONTAINING ALDEHYDES AND HAVING AN ANTIBACTERIAL EFFECT

(75) Inventors: Georg Meine, Mettmann (DE); Andrea Eutebach, Wuppertal (DE); Frank Sonnenschein, Haan (DE); Ralf Bunn, Krefeld (DE)

(73) Assignee: Henkel AG & Co. KGaA, Dusseldorf (DE)

(21) Appl. No.: 13/232,305

(22) Filed: Sep. 14, 2011

Related U.S. Application Data
(63) Continuation of application No. PCT/EP2010/053018, filed on Mar. 10, 2010.

(30) Foreign Application Priority Data
Mar. 20, 2009 (DE) 10 2009 001 688.0

(51) Int. Cl. A01N 59/16; A01P 1/00

(52) U.S. Cl. 424/618

(57) ABSTRACT

The invention relates to an antibacterially active detergent, cleaning agent, aftertreatment agent, or washing aid that contains elementary silver and/or a silver compound as an antibacterial component, an aldehyde component, and hydrogen peroxide to stabilize the aldehydes oxidation.

### CROSS-REFERENCES TO RELATED APPLICATIONS

This application is a continuation of PCT/EP2010/053018, filed on Mar. 10, 2010, which claims priority under 35 U.S.C. §119 to DE 10 2009 001 688.0 filed on Mar. 20, 2009.

### FIELD OF THE INVENTION

The present invention generally relates to an aldehyde-containing washing, cleaning, after treatment or auxiliary washing agent with antibacterial action, comprising elemental silver and/or a silver compound. The invention also relates to the use of, as well as a process for manufacturing such a washing, cleaning, after treatment or auxiliary washing agent.

### BACKGROUND OF THE INVENTION

The adherence of microorganisms on surfaces is unwanted, particularly for pathogenic microorganisms. Adhering microorganisms frequently lead to infections or to reinfections in humans, animals and plants.

Moreover, delicate textiles, such as e.g. silk microfibers, are more and more frequently used for clothing that may only be washed at 30 or 40° C. Consequently, fungi, such as for example the human pathogen Candida albicans, are not destroyed.

However, in addition to the lower washing temperatures, nowadays liquid washing agents that are generally free of bleaching agent are also usually used. For a 60° C. wash, as was previously typical, nearly all germs were reliably killed off, firstly by the higher temperature, secondly by the bleaching agent that was comprised in the typically used universal washing agents.

Consequently, because of the modified washing conditions, textiles contaminated with viruses, bacteria, mold fungi or yeast fungi cannot be made germ-free to an adequate degree, such that a (re)infection can possibly result from renewed contact of the consumer with the supposedly clean washing.

In addition, problems with bad odors can occur because residual germs proliferate on the washing in the course of drying, wearing or storing and produce malodorous metabolites. Moreover, biofilms that adhere to the interior of a washing machine can cause unpleasant odors.

Antimicrobially active compositions and their use in washing, cleaning, after treatment or auxiliary washing agents are known from the prior art. The added disinfectants frequently concern halogen-containing substances or phenol derivatives or other aromatic hydrocarbons which can be considered as problematic on the grounds of environmental sustainability. Other more compatible microbiocides have only a limited activity spectrum or are only effective under certain physical conditions. For domestic applications, however, there is a great need for antimicrobial compositions that are effective against a broad spectrum of microorganisms and which are also environmentally friendly; components of natural origin are likewise desirable.

Silver or silver ions perform inter alia a blocking action on thiol enzymes in microorganisms and thus possess a high bactericidal and fungicidal action. Moreover, silver acts as a germicide. Therefore, germ-reducing washing or cleaning agents, comprising silver and/or silver ions, are already known in the prior art, for example in EP 1 670 885 A1.

Compositions that comprise silver and/or silver ions are often unstable as the silver ions comprised in the agents can react with impurities, such as chloride ions to form light-sensitive silver chloride salts or with sulfide to form poorly soluble silver sulfide salts. In a (strongly) alkaline medium, soluble silver ions initially react to form AgOH and then react further to form sparingly soluble Ag₂O. In addition to the poor solubility of these silver salts, the silver oxides and silver sulfides, in spite of their trace quantities, lead to considerable color changes, in particular a brown or black coloration, of the composition.

Another problem can occur in the presence of aldehydes as these can be oxidized by the silver ions. Washing, cleaning, after treatment or auxiliary washing agents often comprise a perfume oil. Many perfume oils comprise fragrances from the class of the aldehydes. Oxidation of these aldehydes leads, however, to an unwanted, modified fragrance impression.

Accordingly, it is desirable to provide a stable, aldehyde-containing washing, cleaning, after treatment or auxiliary washing agent having antibacterial action.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

It has been surprisingly shown that the elemental silver and/or the silver cation of the silver compound can be stabilized by the presence of hydrogen peroxide, without the occurrence of a reduction in the germicidal activity or of the fragrance impression of the washing, cleaning, after treatment or auxiliary washing agent.

This present invention relates to a washing, cleaning, after treatment or auxiliary washing agent, comprising

(a) elemental silver and/or a silver compound,

(b) an aldehydic compound and

(c) hydrogen peroxide.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The silver compound of the present invention is preferably selected from the group consisting of silver acetate, silver citrate, silverdiamine chloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, silver nitrate, silver chloride on a carrier material and mixtures thereof. The washing, cleaning, after treatment or auxiliary washing agent particularly preferably comprises silver nitrate or silver chloride on a carrier material.

These silver compounds have a sufficiently high solubility and do not precipitate out of the washing, cleaning, after treatment or auxiliary washing agents.

Preferably, the quantity of elemental silver and/or of silver compound is 0.0001 to 1 wt. %, based on the total washing, cleaning, after treatment or auxiliary washing agent.

In a preferred embodiment the aldehyde compound is a fragrance. In this regard, it is particularly preferred that the aldehyde compound is selected from the group consisting of 1,3-benzodioxole-5-carboxaldehyde, 4-hydroxy-3-methoxybenzaldehyde, 2-methyldecanal, 4-(1-methylethyl)benzaldehyde, 10-undecenal, 2-methylundecanal, n-propanal, n-butanal, n-pentanal, n-hexanal, n-heptanal, n-octanal, n-nonanal, n-decanal, n-undecanal, n-dodecanal, 2-(phenylmethylene)heptanal, benzaldehyde, 4-methoxybenzaldehyde, 4-methylbenzaldehyde, 3-(4-tert-butyl-phenyl)isobutyraldehyde, 2-phenylpropanal, 7-hydroxy-3,7-dimethyloctanal, 3-(4-ethylphenyl)-2,2-dimethylpropanal, 3-(4-ethylphenyl)-2,2-dimethylpropanal, trans-3-phenyl-2-propenal, (2Z)-2-(phenylmethylidene)heptanal, 3-(1,3-benzodioxol-5-yl)-2-methylpropanal, 4-(4-methyl-3-pentenyl)-3-cyclohexene-1-carboxaldehyde, 3,7-dimethyl-2,6-octadien-1-al, (E)-3,7-dimethylocta-2,6-dienal, (Z)-3,7-dimethylocta-2,6-dienal, 4-(1,1-dimethylethyl)benzenepropanal, 4-tert-butyl-3-phenylpropanal, 2-methyl-3-(p-isopropylphenyl)propanal, 4-(4-hydroxy-4-methylpentyl)-3-cyclohexene-1-carboxaldehyde, 1-methyl-4-(4-methyl-3-pentenyl)cyclohex-3-ene-1-carbaldehyde, octahydro-5-methoxy-4,7-methano-1H-indene-2-carboxaldehyde, phenylacetaldehyde, 2,4-dimethyl-3-cyclohexene-1-carbaldehyde, 2-methylbenzaldehyde, 3-(3-isopropylphenyl)-butanal, 2,6,10-trimethylundec-9-enal, 3,7-dimethyloctanal, (E)-2-hexenal, 2-methyl-3-(p-tolyl)propionaldehyde, 3-ethoxy-4-hydroxybenzaldehyde, octahydro-8,8-dimethyl-2-naphthalinecarbaldehyde, octahydro-4,7-methano-1H-indenecarbaldehyde, 3,7-dimethyl-6-octenal, [(3,7-dimethyl-6-octenyl)oxy]-acetaldehyde, 2-(phenylmethylene)-hexanal, 2-butyl-3-phenylpropenal, p-tolylacetaldehyde, 4-(octahydro-4,7-methano-5H-inden-5-ylidene)butanal, (4E)-4-decenal, 1-methyl-4-(4-methylpentyl)-3-cyclohexene-1-carbaldehyde, 2,6-dimethyl-5-heptenal, 2-methyl-3-(4-methoxyphenyl)propanal, 4,6-dimethyl-3-cyclohexene-1-carbaldehyde, 2-methyldodecanal, 3-propyl-bicyclo(2.2.1)hept-5-ene-2-carbaldehyde, 4-(1-methylethenyl)-1-cyclo-hexene-1-carbaldehyde, 6,6-dimethylbicyclo[3.1.1]hept-2-ene-2-carbaldehyde, 3-phenylbutanal, 2-methyl-3-phenyl-2-propenal, 2,6-(E/E+E/Z)-nonadienal, 3,7-dimethyl-2-methylene-6-octenal, 3-(4-methylcyclohex-3-enyl)butyraldehyde, phenoxyacetaldehyde, tetradecanal, 3,4-dimethoxybenzaldehyde, 3-methyl-5-phenyl-1-pentanal, 2,6,10-trimethyl-5,9-undecadienal, trimethyl-3-cyclohexene-1-carbaldehyde, 5 (or 6)-methyl-7 (or 8)-(1-methylethyl)bicyclo[2.2.2]oct-5-ene-2-carbaldehyde, 6-methoxy-2,6-dimethylheptanal, 4,8-dimethyl-4,9-decadienal, 2-dodecenal, 7-methoxy-3,7-dimethyloctanal, 4-formyl-2-methoxyphenyl 2-methylpropanoate, 3-methylbutanal, [4-(1,1-dimethylethyl)-2-methylphenoxy]acetaldehyde, 2,6-dimethyl-10-methylene-2,6,11-dodecatrienal, 9-undecenal, 2-methyl-3-(4-(2-methylpropyl)phenyl)propanal, 5,9-dimethyl-4,8-decadienal, 1,2,3,4,5,6,7,8-octahydro-8,8-dimethyl-2-naphthalinecarbaldehyde, 2-methyl-4-(2,6,6-trimethyl-1-cyclohexen-1-yl)-2-butenal, 9-decenal, 2-nonenal, (2E,4E)-2,4-hexadienal, (2E,4Z)-2,4-hexadienal, 2-[(4-methylphenyl)methylene]heptan-1-al, (2E,4E)-2,4-heptadienal, (5Z)-5-octenal, 8-isopropyl-6-methylbicyclo[2.2.2]oct-5-ene-2-carbaldehyde, 7-isopropyl-5-methylbicyclo[2.2.2]oct-5-ene-2-carbaldehyde, (4-methylphenoxy)acetaldehyde, 3-(2-methoxyphenyl)-2-propenal, [[(2E)-3,7-dimethyl-2,6-octadienyl]oxy]acetaldehyde, phenylpropanal, [(3a,4,5,6,7,7a-hexahydro-4,7-methano-1H-inden-5-yl)oxy]acetaldehyde, [(3a,4,5,6,7,7a-hexahydro-4,7-methano-1H-inden-6-yl)oxy]acetaldehyde, 3,7-dimethyl-3,6-octadienal, 5-methyl-2-furancarbaldehyde, 2,6,6-trimethyl-1,3-cyclohexadiene-1-carbaldehyde, 3-(1,1-dimethylethyl)-alpha-methylphenylpropanal, 2-[(3,7-dimethyloctyl)oxy]acetaldehyde, 6,6-dimethylbicyclo[3.1.1]hept-2-ene-2-propanal, (2E)-2-dodecenal, 2-tridecenal, (2E,4E)-2,4-decadienal, (2E,4E)-2,4-nonadienal, (2E,4E)-2,4-undecadienal, (6Z)-6-nonenal, (4Z)-4-decenal, 4-(1-methylethyl)-1,3-cyclohexadiene-1-carbaldehyde, (4Z)-dodecadienal, (2E,4E)-2,4-octadienal, (2E,4E)-2,4-dodecadienal, (2E,4Z)-2,4-dodecadienal, 2,4-tridecadienal, 4-(1-methylethyl)-1,4-cyclohexadiene-1-carbaldehyde and mixtures thereof.

The fragrance impression of a washing, cleaning, after treatment or auxiliary washing agent itself as well as the fragrance impression that remains from a washing, cleaning, after treatment or auxiliary washing agent on a textile treated with it is often a deciding factor for the purchasing decision of consumers. The listed aldehyde compounds are commonly and frequently used fragrances that decisively contribute to the fragrance impression of a perfume composition.

It can be preferred that the washing, cleaning, after treatment or auxiliary washing agent additionally comprises 0.01 to 3 wt. % ammonium hydroxide, based on the total washing, cleaning, after treatment or auxiliary washing agent. Surprisingly, it has been found that particularly clear and hence esthetically appealing compositions are obtained by adding just low amounts of ammonium hydroxide.

The invention also relates to the use of a washing, cleaning, after treatment or auxiliary washing agent according to the invention for the washing, cleaning, pretreatment and/or conditioning of textiles.

The invention further also relates to a process for manufacturing a washing, cleaning, after treatment or auxiliary washing agent, comprising (a) an aldehydic compound and (b) elemental silver and/or a silver compound, in which said aldehydic compound and said elemental silver and/or said silver compound are added by means of a perfume composition that additionally comprises hydrogen peroxide.

Perfume compositions are usually added at the end of a manufacturing process for washing, cleaning, after treatment or auxiliary washing agents. By adding the elemental silver and/or silver compounds together with the perfume composition, there results a specialization of the manufactured washing, cleaning, after treatment or auxiliary washing agent into an antibacterial washing, cleaning, after treatment or auxiliary washing agent, also quite late in the manufacturing process, and a preparation can be used in order to manufacture the most varied categories of washing, cleaning, after treatment or auxiliary washing agents. Moreover, through the perfume composition, the lowest amounts of aldehydic compound, hydrogen peroxide, elemental silver and/or silver compound can be easily and quickly added to a washing, cleaning, after treatment or auxiliary washing agent.

The invention also relates to the use of hydrogen peroxide for stabilizing an aldehyde-containing composition that contains silver and/or a silver compound.

Likewise, the invention relates to a perfume composition, preferably for use in a washing, cleaning, after treatment or auxiliary washing agent, containing (a) elemental silver and/or a silver compound, (b) an aldehydic compound and (c) hydrogen peroxide.

The invention is intended to be described below in more detail inter alia by means of examples.

The washing, cleaning, after treatment or auxiliary washing agent comprises elemental silver and/or a silver compound as an essential component.

Silver is inventively added in elemental form or in the form of its compounds. If the silver is added in elemental form then its particle size is preferably between 1 μm and 100 μm. Even finer particle sizes of the silver can be achieved by adding the elemental silver in colloidal form, wherein the particle size of the silver is between 0.001 to 0.1 μm.

Indeed it is preferred that the agent comprises a silver compound and that this silver compound is selected from the group consisting of silver acetate, silver citrate, silverdiamine chloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, silver nitrate, silver chloride on a carrier material and mixtures thereof. The silver compounds are preferably added in the form of solutions, suspensions or dispersions. The washing, cleaning, after treatment or auxiliary washing agent particularly preferably comprises silver nitrate that is added in the form of an aqueous solution, or silver chloride on titanium dioxide as a carrier material that is added as an aqueous dispersion.

Preferably, the quantity of elemental silver and/or of silver compound is 0.0001 to 1 wt. % and more preferably between 0.001 and 0.25 wt. %, based on the total washing, cleaning, after treatment or auxiliary washing agent. Quite particularly preferred washing, cleaning, after treatment or auxiliary washing agents comprise 0.001 to 0.1 wt. % elemental silver and/or silver compound, based on the total washing, cleaning, after treatment or auxiliary washing agent.

The washing, cleaning, after treatment or auxiliary washing agent additionally comprises an aldehydic compound. Aldehydes can be added for a variety of reasons, such as for example for disinfection, in washing, cleaning, after treatment or auxiliary washing agents. A major purpose, however, is as a fragrance in perfume compositions.

Suitable aldehydic fragrances that can be comprised in a washing, cleaning, after treatment or auxiliary washing agent include for example 1,3-benzodioxole-5-carboxaldehyde, 4-hydroxy-3-methoxybenzaldehyde, 2-methyldecanal, 4-(1-methylethyl)benzaldehyde, 10-undecenal, 2-methylundecanal, n-propanal, n-butanal, n-pentanal, n-hexanal, n-heptanal, n-octanal, n-nonanal, n-decanal, n-undecanal, n-dodecanal, 2-(phenylmethylene)heptanal, benzaldehyde, 4-methoxybenzaldehyde, 4-methylbenzaldehyde, 3-(4-tert-butyl-phenyl)isobutyraldehyde, 2-phenylpropanal, 7-hydroxy-3,7-dimethyloctanal, 3-(4-ethylphenyl)-2,2-dimethylpropanal, 3-(4-ethylphenyl)-2,2-dimethylpropanal, trans-3-phenyl-2-propenal, (2Z)-2-(phenylmethylidene)heptanal, 3-(1,3-benzodioxol-5-yl)-2-methylpropanal, 4-(4-methyl-3-pentenyl)-3-cyclohexene-1-carboxaldehyde, 3,7-dimethyl-2,6-octadien-1-al, (E)-3,7-dimethylocta-2,6-dienal, (Z)-3,7-dimethylocta-2,6-dienal, 4-(1,1-dimethylethyl)benzenepropanal, 4-tert-butyl-3-phenylpropanal, 2-methyl-3-(p-isopropylphenyl)propanal, 4-(4-hydroxy-4-methylpentyl)-3-cyclohexene-1-carboxaldehyde, 1-methyl-4-(4-methyl-3-pentenyl)cyclohex-3-ene-1-carbaldehyde, octahydro-5-methoxy-4,7-methano-1H-indene-2-carboxaldehyde, phenylacetaldehyde, 2,4-dimethyl-3-cyclohexene-1-carbaldehyde, 2-methylbenzaldehyde, 3-(3-isopropylphenyl)-butanal, 2,6,10-trimethylundec-9-enal, 3,7-dimethyloctanal, (E)-2-hexenal, 2-methyl-3-(p-tolyl)propionaldehyde, 3-ethoxy-4-hydroxybenzaldehyde, octahydro-8,8-dimethyl-2-naphthalinecarbaldehyde, octahydro-4,7-methano-1H-indenecarbaldehyde, 3,7-dimethyl-6-octenal, [(3,7-dimethyl-6-octenyl)oxy]-acetaldehyde, 2-(phenylmethylene)-hexanal, 2-butyl-3-phenylpropenal, p-tolylacetaldehyde, 4-(octahydro-4,7-methano-5H-inden-5-ylidene)butanal, (4E)-4-decenal, 1-methyl-4-(4-methylpentyl)-3-cyclohexene-1-carbaldehyde, 2,6-dimethyl-5-heptenal, 2-methyl-3-(4-methoxyphenyl)propanal, 4,6-dimethyl-3-cyclohexene-1-carbaldehyde, 2-methyldodecanal, 3-propyl-bicyclo(2.2.1)hept-5-ene-2-carbaldehyde, 4-(1-methylethenyl)-1-cyclo-hexene-1-carbaldehyde, 6,6-dimethylbicyclo[3.1.1]hept-2-ene-2-carbaldehyde, 3-phenylbutanal, 2-methyl-3-phenyl-2-propenal, 2,6-(E/E+E/Z)-nonadienal, 3,7-dimethyl-2-methylene-6-octenal, 3-(4-methylcyclohex-3-enyl)butyraldehyde, phenoxyacetaldehyde, tetradecanal, 3,4-dimethoxybenzaldehyde, 3-methyl-5-phenyl-1-pentanal, 2,6,10-trimethyl-5,9-undecadienal, trimethyl-3-cyclohexene-1-carbaldehyde, 5 (or 6)-methyl-7 (or 8)-(1-methylethyl)bicyclo[2.2.2]oct-5-ene-2-carbaldehyde, 6-methoxy-2,6-dimethylheptanal, 4,8-dimethyl-4,9-decadienal, 2-dodecenal, 7-methoxy-3,7-dimethyloctanal, 4-formyl-2-methoxyphenyl 2-methylpropanoate, 3-methylbutanal, [4-(1,1-dimethylethyl)-2-methylphenoxy]acetaldehyde, 2,6-dimethyl-10-methylene-2,6,11-dodecatrienal, 9-undecenal, 2-methyl-3-(4-(2-methylpropyl)phenyl)propanal, 5,9-dimethyl-4,8-decadienal, 1,2,3,4,5,6,7,8-octahydro-8,8-dimethyl-2-naphthalinecarbaldehyde, 2-methyl-4-(2,6,6-trimethyl-1-cyclohexen-1-yl)-2-butenal, 9-decenal, 2-nonenal, (2E,4E)-2,4-hexadienal, (2E,4Z)-2,4-hexadienal, 2-[(4-methylphenyl)methylene]heptan-1-al, (2E,4E)-2,4-heptadienal, (5Z)-5-octenal, 8-isopropyl-6-methylbicyclo[2.2.2]oct-5-ene-2-carbaldehyde, 7-isopropyl-5-methylbicyclo[2.2.2]oct-5-ene-2-carbaldehyde, (4-methylphenoxy)acetaldehyde, 3-(2-methoxyphenyl)-2-propenal, [[(2E)-3,7-dimethyl-2,6-octadienyl]oxy]acetaldehyde, phenylpropanal, [(3a,4,5,6,7,7a-hexahydro-4,7-methano-1H-inden-5-yl)oxy]acetaldehyde, [(3a,4, 5, 6,7,7a-hexahydro-4,7-methano-1H-inden-6-yl)oxy]acetaldehyde, 3,7-dimethyl-3,6-octadienal, 5-methyl-2-furancarbaldehyde, 2,6,6-trimethyl-1,3-cyclohexadiene-1-carbaldehyde, 3-(1,1-dimethylethyl)-alpha-methylphenylpropanal, 2-[(3,7-dimethyloctyl)oxy]acetaldehyde, 6,6-dimethylbicyclo[3.1.1]hept-2-ene-2-propanal, (2E)-2-dodecenal, 2-tridecenal, (2E,4E)-2,4-decadienal, (2E,4E)-2,4-nonadienal, (2E,4E)-2,4-undecadienal, (6Z)-6-nonenal, (4Z)-4-decenal, 4-(1-methylethyl)-1,3-cyclohexadiene-1-carbaldehyde, (4Z)-dodec-4-en-1-al, (2E,4E)-2,4-octadienal, (2E,4E)-2,4-dodecadienal, (2E,4Z)-2,4-dodecadienal, 2,4-tridecadienal, 4-(1-methylethyl)-1,4-cyclohexadiene-1-carbaldehyde and mixtures thereof.

The aldehyde is preferably a constituent of a perfume composition and in this way ends up in the washing, cleaning, after treatment or auxiliary washing agent.

The amount of aldehydic compound can be between 0.001 and 5 wt. %, based on the total washing, cleaning, after treatment or auxiliary washing agent.

Under certain conditions the added aldehydes can enhance the primary activity of the germicidal agent, here elemental silver or a silver compound, i.e. they themselves possess an antibacterial/germicidal activity.

The perfume composition can, in addition to one or more aldehydic compound(s), comprise additional fragrances, such as for example the synthetic products of the ester, ether, ketone, alcohol and hydrocarbon type. Mixtures of various fragrances, which together produce an attractive fragrant note, are preferably used. A perfume composition can also comprise natural fragrance mixtures that are obtainable from vegetal sources. In addition the perfume composition can contain organic solvents and/or surfactants.

The composition comprises hydrogen peroxide as the third essential constituent. The amount of hydrogen peroxide is preferably between 0.01 and 5 wt. % and quite particularly preferably between 0.1 and 2.5 wt. %.

In the aldehydic and silver containing agents the hydrogen peroxide serves, so to speak, as a “sacrificial anode” and prevents unwanted reactions between the aldehydes and the silver compound. In particular, the hydrogen peroxide prevents the aldehyde being oxidized by the silver compound. Surprisingly, it has been established that the hydrogen peroxide undergoes no unwanted reactions with the additional constituents, for example the fragrances, of the washing, cleaning, after treatment or auxiliary washing agent.

In addition to the elemental silver or the silver compound, the aldehydic compound and the hydrogen peroxide, the washing, cleaning, after treatment or auxiliary washing agent can comprise further ingredients that further improve the technical application characteristics and/or esthetic properties of the washing, cleaning, after treatment or auxiliary washing agent. In the context of the present invention, the washing, cleaning, after treatment or auxiliary washing agent preferably additionally comprises one or a plurality of materials from the group of the surfactants, builders, bleaching agents, bleach catalysts, bleach activators, enzymes, electrolytes, non-aqueous solvents, pH adjustors, perfume compositions, perfume carriers, fluorescent agents, dyes, hydrotropes, foam inhibitors, silicone oils, soil-release polymers, graying inhibitors, shrink preventers, anti-crease agents, color transfer inhibitors, additional antimicrobials, germicides, fungicides, antioxidants, preservatives, corrosion inhibitors, antistats, bittering agents, ironing aids, water-repellents and impregnation agents, swelling and non-skid agents, softening components and UV-absorbers.

Particularly preferred additional ingredients are surfactants, builders, enzymes, electrolytes, non-aqueous solvents, pH adjustors, perfume compositions, fluorescent agents, dyes, hydrotropes, foam inhibitors, silicone oils, soil-release polymers, graying inhibitors, color transfer inhibitors, softening components, UV-absorbers as well as mixtures thereof.

The washing, cleaning, after treatment or auxiliary washing agent preferably comprises 1 to 60 wt. % of a surfactant, selected from the group consisting of anionic, non-ionic, cationic and zwitterionic surfactants as well as mixtures thereof.

Suitable non-ionic surfactants include alkoxylated fatty alcohols, alkoxylated fatty acid alkyl esters, fatty acid amides, alkoxylated fatty acid amides, polyhydroxyfatty acid amides, alkylphenol polyglycol ethers and mixtures thereof.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in oxo alcohol groups. In particular, however, alcohol ethoxylates with linear alcohol groups of natural origin with 12 to 18 carbon atoms, e.g. from coco-, palm-, tallow- or oleyl alcohol, and an average of 2 to 8 EO per mole alcohol are preferred. Exemplary preferred ethoxylated alcohols include C₁₂₋₁₄ alcohols with 3 EO or 4 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, such as mixtures of C₁₂₋₁₄ alcohol with 3 EO and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Further suitable is also a mixture of a (highly) branched ethoxylated fatty alcohol and a linear ethoxylated fatty alcohol, such as for example a mixture of a C₁₆₋₁₈ fatty alcohol with 7 EO and 2-propylheptanol with 7 EO. The washing, cleaning, after treatment or auxiliary washing agent particularly preferably comprises a C₁₂₋₁₈ fatty alcohol with 7 EO or a C₁₃₋₁₅ oxo alcohol with 7 EO.

Suitable amine oxides include for example alkylamine oxides, more particularly alkyldimethylamine oxides, alkylamido amine oxides and alkoxyalkylamine oxides. Preferred amine oxides satisfy Formula II, and IIa

R⁶R⁷R⁸N⁺—O⁻ (II)

R⁶—[CO—NH—(CH₂)_{w}]_{z}—N⁺(R⁷)(R⁸)—O (IIa)

in which
R⁶ is a saturated or unsaturated C₆₋₂₂ alkyl group, preferably a C₈₋₁₈ alkyl group, in particular a saturated C₁₀₋₁₆ alkyl group, for example a saturated C₁₂₋₁₄ alkyl group, that is attached to the nitrogen atom N in the alkylamido amine oxides through a carbonylamido alkylene group —CO—NH—(CH₂)_{z}— and in the alkoxyalkylamine oxides through an oxyalkylene group —O—(CH₂)_{z}—, wherein each z is a number from 1 to 10, preferably 2 to 5, especially 3,
R⁷, R⁸ independently of one another are an optionally hydroxy substituted C₁₋₄ alkyl group such as, for example, a hydroxyethyl group, especially a methyl group.

Preferred exemplary amine oxides are N-cocoalkyl-N,N-dimethylamine oxide, N-tallowalkyl-N,N-dihydroxyethylamine oxide, myristylcetyldimethylamine oxide or lauryldimethylamine oxide.

The amine oxide content in the washing, cleaning, after treatment or auxiliary washing agent is advantageously 1 to 15 wt. %, preferably 2 to 10 wt. %, each based on the total washing, cleaning, after treatment or auxiliary washing agent.

Alternatively to or in addition to the non-ionic surfactant(s), the washing, cleaning, after treatment or auxiliary washing agent can also comprise an anionic surfactant as the auxiliary washing agent compound. Sulfonates, sulfates, soaps, alkyl phosphates, anionic silico-surfactants and mixtures thereof are preferably employed as the anionic surfactant.

Suitable surfactants of the sulfonate type are, advantageously C₉₋₁₃ alkylbenzene sulfonates, olefin sulfonates, i.e. mixtures of alkene- and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. C₁₂₋₁₈ alkane sulfonates and the esters of α-sulfofatty acids (ester sulfonates), e.g. the α-sulfonated methyl esters of hydrogenated coco-, palm nut- or tallow acids are likewise suitable.

Preferred alk(en)yl sulfates are the alkali metal and especially sodium salts of the sulfuric acid half-esters derived from the C₁₂₋₁₈ fatty alcohols, for example from coconut butter alcohol, tallow alcohol, lauryl, myristyl, cetyl or stearyl alcohol or from C₁₀₋₂₀ oxo alcohols and those half-esters of secondary alcohols of these chain lengths. The C₁₂-C₁₆ alkyl sulfates and C₁₂-C₁₅ alkyl sulfates and C₁₄-C₁₅ alkyl sulfates are preferred on the grounds of washing performance. 2,3-Alkyl sulfates are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO.

Soaps are also preferred anionic surfactants. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

The anionic surfactants, including the soaps, can be present in the form of their sodium, potassium or magnesium or ammonium salts. The anionic surfactants are preferably present in the form of their sodium salts. Further preferred counter ions for the anionic surfactants are also the protonated forms of choline, triethylamine or methylethylamine.

It can be preferred that a fatty acid soap is present in the mixture with the non-neutralized fatty acid, because the non-neutralized fatty acid effects an additional stabilization of the silver-containing washing, cleaning, after treatment or auxiliary washing agent, in particular the elemental silver and/or the silver compound.

After treatment agents in the form of fabric softeners advantageously comprise cationic surfactants that exhibit a softening effect.

The cationic surfactants include for example quaternary ammonium compounds such as mono-alk(en)yltrimethylammonium compounds, dialk(en)yldimethylammonium compounds, mono-, di- or triesters of fatty acids with alkanolamines.

Suitable examples of quaternary ammonium compounds are shown for example in the Formulas (III) to (V):

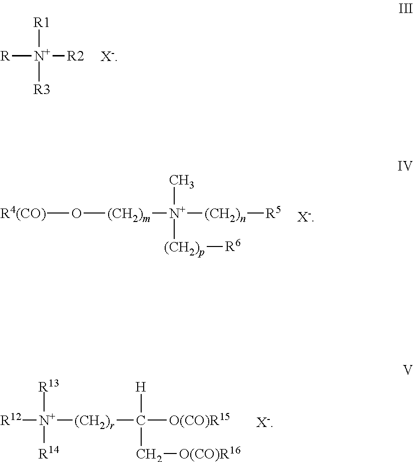

wherein in (III) R stands for an alkyl group having 12 to 24 carbon atoms, R¹ stands for a saturated C₁-C₄ alkyl or hydroxyalkyl group, R² and R³ are either equal to R or R¹ or stand for an aromatic group. X⁻ stands either for a halide ion, methosulfate ion, methophosphate ion or phosphate ion as well as their mixtures. Exemplary cationic compounds of Formula (III) are monotallowtrimethylammonium chloride, mono stearyltrimethylammonium chloride, didecyldimethylammonium chloride, ditallowedimethylammonium chloride or dihexadecylammonium chloride.

Compounds of Formula (IV) and (V) are so-called esterquats. Esterquats are characterized by their outstanding biodegradability. In Formula (IV), R⁴ stands for an aliphatic alk(en)yl group containing 12 to 22 carbon atoms with 0, 1, 2 or 3 double bonds and/or optionally with substituents; R⁵ stands for H, OH or O(CO)R⁷, R⁶ independently of R⁵ stands for H, OH or O(CO)R⁸, wherein R⁷ and R⁸, independently of each other, each stand for an aliphatic alk(en)yl group having 12 to 22 carbon atoms with 0, 1, 2 or 3 double bonds, m, n, and p independently of each other can each have the value 1, 2 or 3. X⁻ can be either a halide ion, methosulfate ion, methophosphate ion or phosphate ion as well as mixtures of these anions. Compounds are preferred in which R⁵ represents the group O(CO)R⁷.

Compounds are particularly preferred in which R⁵ represents the group O(CO)R⁷ and R⁴ and R⁷ are alk(en)yl groups with 16 to 18 carbon atoms. Particularly preferred are compounds in which R⁶ stands moreover for OH. In Formula (V) R¹², R¹³ and R¹⁴ independently of one another stand for a C₁₋₄ alkyl, alkenyl or hydroxyalkyl group, R¹⁵ and R¹⁶, each independently selected, represents a C₈₋₂₈ alkyl group, X⁻ is an anion and r is a number between 0 and 5. Examples include methyl-N-(2-hydroxyethyl)-N,N-di(tallowacyloxyethyl)ammonium methosulfate, bis-(palmitoyloxyethyl)-hydroxyethyl-methylammonium methosulfate, 1,2-bis-[tallowacyloxy]-3-trimethylammonium propane chloride, methyl-N,N-bis(stearoyloxyethyl)-N-(2-hydroxyethyl)ammonium methosulfate or N,N-dimethyl-N,N-di(tallowacyloxyethyl)ammonium methosulfate.

Instead of the ester group O(CO)R, wherein R stands for a long chain alk(en)yl group, softening compounds can be added that possess the following groups: RO(CO), N(CO)R or RN(CO), wherein the N(CO)R groups are preferred among these groups.

The additional ingredients and the physical parameters of the washing, cleaning, after treatment or auxiliary washing agent are dependent on its application (universal washing agents, washing agents for coloreds, fabric softeners, etc.). A person skilled in the art is aware of which ingredient to be selected and combined in which amounts. Ethoxylated fatty acid amides, for example, can be added as a detergency booster.

The inventive washing, cleaning, after treatment or auxiliary washing agents are preferably liquid and comprise water as the principal solvent.

The inventive washing or cleaning agents are manufactured by means of usual and known methods and processes. Thus for example the ingredients can be simply blended in stirred vessels, wherein water, the acidic components, when present, such as for example the citric acid, and the non-ionic surfactants, when present, are expediently provided. The further ingredients, including the hydrogen peroxide and the aldehydic compound, are then added, preferably batch-wise. In the last step the elemental silver or the silver compound is added.

An inventive after treatment agent in the form of a fabric softener can be manufactured by techniques commonly used by the person skilled in the art for manufacturing fabric softeners. For example, this can be carried out by mixing the raw materials, optionally by using high shear mixers. It is recommended to melt the cationic surfactants and to subsequently disperse the melt in a solvent, preferably water. The additional ingredients, including the hydrogen peroxide and the aldehydic compound, can be incorporated by a simple mixing into the fabric softener. Also here, the elemental silver or the silver compound is added in the last step.

In all cases, the aldehydic compound is preferably comprised in a perfume composition and is added by this means to the agent.

### EXAMPLES

In Table 1 are shown the compositions of a comparative formulation V1 and the compositions of five inventive washing, cleaning, after treatment or auxiliary washing agents E1 to E5 (all quantities are given in wt. % active substance, based on the composition):

TABLE 1

| | V1 | E1 | E2 | E3 | E4 | E5 |
|---|---|---|---|---|---|---|
| C₁₂₋₁₈ fatty | 12 | 12 | 12 | 5 | 5 | — |
| alcohol with 7 | | | | | | |
| EO | | | | | | |
| N-cocoalkyl- | 1.95 | 1.95 | 1.95 | 2 | 2 | — |
| N,N- | | | | | | |
| dimethylamine | | | | | | |
| oxide | | | | | | |
| Esterquat* | — | — | — | — | — | 15 |
| AgNO₃•H₂O | 0.0043 | 0.0043 | 0.0043 | 0.004 | 0.004 | 0.004 |
| C₁₄ fatty acid | 5 | 5 | — | — | — | |
| Farnesol | 0.02 | 0.02 | 0.02 | 0.02 | 0.02 | 0.02 |
| Coco fatty | 2.5 | 2.5 | 2.5 | 12 | — | — |
| acid | | | | | | |
| Citric acid | — | — | — | 1.0 | 0.1 | — |
| H₂O₂ | — | 0.50 | 0.035 | 2 | 5 | 0.5 |
| NaOH | 0.35 | 0.35 | 0.35 | 1.9 | — | — |
| NH₄OH | 0.04 | 0.04 | 0.04 | 0.06 | — | — |
| 2-Propanol | — | — | — | — | — | 1.67 |
| MgCl₂ × 6 | — | — | — | — | — | 0.01 |
| H₂O | | | | | | |
| Perfume A | 1.00 | 1.00 | 1.00 | 1.00 | 1.00 | 0.75 |
| Water | Ad 100 | Ad 100 | Ad 100 | Ad 100 | Ad 100 | Ad 100 |
| pH | 8.5 | 8.5 | 8.5 | 8.5 | 5.5 | 2.6 |

*N-Methyl-N-(2-hydroxyethyl)-N,N-(ditallowacyloxyethyl)ammonium methosulfate

The perfume composition A comprised, based on 1000 parts of the perfume composition, a total of 132 parts 3-(4-tert-butylphenyl)isobutyraldehyde (lilial), 35 parts 2-methylundecanal (Aldehyd C12 nm a) and 6 parts 4,6-dimethyl-3-cyclohexene-1-carbaldehyde (Cyclovertal) as the aldehydic fragrances.

With the washing agent V1 a significant, gray-black coloration as well as a change in the fragrance impression occurred already after a few hours, whereas with the inventive washing, cleaning, after treatment or auxiliary washing agents with the compositions E1 to E5 no change in coloration occurred even after longer storage times. The fragrance impression of the washing, cleaning, after treatment or auxiliary washing agents E1 to E5 also remained virtually unchanged.

For detecting and determining the antimicrobial power of the washing, cleaning, after treatment or auxiliary washing agents, a first laundry batch was washed with the comparative washing agent V1 and a second laundry batch was washed with the inventive washing agent E1. The damp washing was left 6 hours in the washing machine at the end of the respective wash cycle and then subjected to an odor assessment by a trained test person.

The odor of the second laundry batch that had been treated with the auxiliary washing agent E1 was assessed as “fresh”, whereas the first laundry batch smelled more “fusty”.

This test clearly shows that the inventive washing, cleaning, after treatment or auxiliary washing agents have an antibacterial action and for example the appearance of unpleasant odors, caused by bacteria, when storing damp washing can be suppressed or reduced.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing agent, comprising
(a) elemental silver and/or a silver compound,
(b) an aldehydic compound and
(c) hydrogen peroxide.

2. The washing agent according to claim 1, wherein the silver compound is selected from the group consisting of silver acetate, silver citrate, silverdiamine chloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, silver nitrate, silver chloride on a carrier material and mixtures thereof.

3. The washing agent according to claim 1, wherein the quantity of elemental silver and/or of silver compound is 0.0001 to 1 wt. %, based on the total washing agent.

4. The washing agent according to claim 1, wherein the aldehydic compound is a fragrance.

5. The washing agent according to claim 4, wherein the aldehydic compound is selected from the group consisting of 1,3-benzodioxole-5-carboxaldehyde, 4-hydroxy-3-methoxybenzaldehyde, 2-methyldecanal, 4-(1-methylethyl)benzaldehyde, 10-undecenal, 2-methylundecanal, n-propanal, n-butanal, n-pentanal, n-hexanal, n-heptanal, n-octanal, n-nonanal, n-decanal, n-undecanal, n-dodecanal, 2-(phenylmethylene)heptanal, benzaldehyde, 4-methoxybenzaldehyde, 4-methylbenzaldehyde, 3-(4-tert-butyl-phenyeisobutyraldehyde, 2-phenylpropanal, 7-hydroxy-3,7-dimethyloctanal, 3-(4-ethylphenyl)-2,2-dimethylpropanal, 3-(4-ethylphenyl)-2,2-dimethylpropanal, trans-3-phenyl-2-propenal, [(2Z)-2-(phenylmethylidene)heptanal, 3-(1,3-benzodioxol-5-yl)-2-methylpropanal, 4-(4-methyl-3-pentenyl)-3-cyclohexene-1-carboxaldehyde, 3,7-dimethyl-2,6-octadien-1-al, (E)-3,7-dimethylocta-2,6-dienal, (Z)-3,7-dimethylocta-2,6-dienal, 4-(1,1-dimethylethyl)benzenepropanal, 4-tert-butyl-3-phenylpropanal, 2-methyl-3-(p-isopropylphenyl)propanal, 4-(4-hydroxy-4-methylpentyl)-3-cyclohexene-1-carboxaldehyde, 1-methyl-4-(4-methyl-3-pentenyl)cyclohex-3-ene-1-carbaldehyde, octahydro-5-methoxy-4,7-methano-1H-indene-2-carboxaldehyde, phenylacetaldehyde, 2,4-dimethyl-3-cyclohexene-1-carbaldehyde, 2-methylbenzaldehyde, 3-(3-isopropylphenyl)-butanal, 2,6,10-trimethylundec-9-enal, 3,7-dimethyl octanal, (E)-2-hexenal, 2-methyl-3-(p-tolyl)propionaldehyde, 3-ethoxy-4-hydroxybenzaldehyde, octahydro-8,8-dimethyl-2-naphthalinecarbaldehyde, octahydro-4,7-methano-1H-indenecarbaldehyde, 3,7-dimethyl-6-octenal, [(3,7-dimethyl-6-octenyl)oxy]-acetaldehyde, 2-(phenylmethylene)-hexanal, 2-butyl-3-phenylpropenal, p-tolylacetaldehyde, 4-(octahydro-4,7-methano-5H-inden-5-ylidene)butanal, (4E)-4-decenal, 1-methyl-4-(4-methylpentyl)-3-cyclohexene-1-carbaldehyde, 2,6-dimethyl-5-heptenal, 2-methyl-3-(4-methoxyphenyl)propanal, 4,6-dimethyl-3-cyclohexene-1-carbaldehyde, 2-methyldodecanal, 3-propyl-bicyclo(2.2.1)hept-5-ene-2-carbaldehyde, 4-(1-methylethenyl)-1-cyclo-hexene-1-carbaldehyde, 6,6-dimethylbicyclo[3.1.1]hept-2-ene-2-carbaldehyd, 3-phenylbutanal, 2-methyl-3-phenyl-2-propenal, 2,6-(E/E+E/Z)-nonadienal, 3,7-dimethyl-2-methylene-6-octenal, 3-(4-methylcyclohex-3-enyl)butyraldehyde, phenoxyacetaldehyde, tetradecanal, 3,4-dimethoxybenzaldehyde, 3-methyl-5-phenyl-1-pentanal, 2,6,10-trimethyl-5,9-undecadienal, trimethyl-3-cyclohexene-1-carbaldehyde, 5 (or 6)-methyl-7 (or 8)-(1-methylethyl)bicyclo[2.2.2]oct-5-ene-2-carbaldehyde, 6-methoxy-2,6-dimethylheptanal, 4,8-dimethyl-4,9-decadienal, 2-dodecenal, 7-methoxy-3,7-dimethyloctanal, 4-formyl-2-methoxyphenyl 2-methylpropanoate, 3-methylbutanal, [4-(1,1-dimethylethyl)-2-methylphenoxy]acetaldehyde, 2,6-dimethyl-10-methylene-2,6,11-dodecatrienal, 9-undecenal, 2-methyl-3-(4-(2-methylpropyl)phenyl)propanal, 5,9-dimethyl-4,8-decadienal, 1,2,3,4,5,6,7,8-octahydro-8,8-dimethyl-2-naphthalinecarbaldehyde, 2-methyl-4-(2,6,6-trimethyl-1-cyclohexen-1-yl)-2-butenal, 9-decenal, 2-nonenal, (2E,4E)-2,4-hexadienal, (2E,4Z)-2,4-hexadienal, 2-[(4-methylphenyl)methylene]heptan-1-al, (2E,4E)-2,4-heptadienal, (5Z)-5-octenal, 8-isopropyl-6-methylbicyclo[2.2.2]oct-5-ene-2-carbaldehyde, 7-isopropyl-5-methylbicyclo[2.2.2]oct-5-ene-2-carbaldehyde, (4-methylphenoxy)acetaldehyde, 3-(2-methoxyphenyl)-2-propenal, [[(2E)-3,7-dimethyl-2,6-octadienyl]oxy]acetaldehyde, phenylpropanal, [(3a,4,5,6,7,7a-hexahydro-4,7-methano-1H-inden-5-yl)oxy]acetaldehyde, [(3a,4,5,6,7,7a-hexahydro-4,7-methano-1H-inden-6-yl)oxy]acetaldehyde, 3,7-dimethyl-3,6-octadienal, 5-methyl-2-furancarbaldehyde, 2,6,6-trimethyl-1,3-cyclohexadiene-1-carbaldehyde, 3-(1,1-dimethylethyl)-alpha-methylphenylpropanal, 2-[(3,7-dimethyloctyl)oxy]acetaldehyde, 6,6-dimethylbicyclo[3.1.1]hept-2-ene-2-propanal, (2E)-2-dodecenal, 2-tridecenal, (2E,4E)-2,4-decadienal, (2E,4E)-2,4-nonadienal, (2E,4E)-2,4-undecadienal, (6Z)-6-nonenal, (4Z)-4-decenal, 441-methylethyl)-1,3-cyclohexadiene-1-carbaldehyde, (4Z)-dodec-4-en-1-al, (2E,4E)-2,4-octadienal, (2E,4E)-2,4-dodecadienal, (2E,4Z)-2,4-dodecadienal, 2,4-tridecadienal, 4-(1-methylethyl)-1,4-cyclohexadiene-1-carbaldehyde and mixtures thereof.

6. The washing, cleaning, after treatment or auxiliary washing agent according to claim 1, additionally comprising 0.01 to 3 wt. % ammonium hydroxide, based on the total washing agent.

7. Use of a washing agent according to claim 1 in the washing, cleaning, pretreating and/or conditioning of textiles.

8. A process for manufacturing a washing agent, comprising (a) an aldehydic compound and (b) elemental silver and/or a silver compound, in which said aldehydic compound and said elemental silver and/or said silver compound are added by means of a perfume composition that additionally comprises hydrogen peroxide.

9. Use of hydrogen peroxide for stabilizing an aldehyde-containing composition that contains silver and/or a silver compound.

10. A perfume composition for use in a washing agent, containing (a) elemental silver and/or a silver compound, (b) an aldehydic compound and (c) hydrogen peroxide.
